(19) United States
(12) Patent Application Publication
(10) Pub. No.: US 2011/0209796 A1
(43) Pub. Date: Sep. 1, 2011

(54) METHOD AND APPARATUS FOR THE STERILE FILLING OF TWO DIFFERENT PRODUCT FLOWS INTO A CONTAINER

(75) Inventor: Roland Feilner, Regensburg (DE)

(73) Assignee: KRONES AG, Neutraubling (DE)

(21) Appl. No.: 13/034,779

(22) Filed: Feb. 25, 2011

(30) Foreign Application Priority Data
Feb. 26, 2010 (DE) 102010002407.4

(51) Int. Cl. B65B 1/04; B67D 7/74; B67D 7/06

(52) U.S. Cl. 141/9; 222/1; 222/145.5

(57) ABSTRACT

A method and an apparatus for the sterile filling of two different product flows into a container, where the first product flow is thermally treated for pasteurizing/sterilizing, is cooled down and fed to a filling valve, and the second product flow is thermally treated for pasteurizing/sterilizing, and then, in the hot state, is added to the first product flow upstream of or in the filling valve.

### CROSS-REFERENCE TO RELATED APPLICATION

The present application claims the benefit of priority of German Application No. 102010002407.4, filed Feb. 26, 2010. The entire text of the priority application is incorporated herein by reference in its entirety.

### FIELD OF THE DISCLOSURE

The disclosure relates to a method and an apparatus for the sterile filling of two different product flows into a container.

### BACKGROUND

The filling of piece-containing products, e.g. juices with portions of fruit pieces, involves the filling of two different product flows, e.g. a first product flow of water or juice, and a second product flow, e.g. of juice with fruit pieces, into a container. Basically, there are two possibilities for the sterile filling. Both product flows can be treated thermally and conveyed in a hot state to a filler, where the product flows are separately filled into a container. In this case, the filled in product needs a relatively long time until it has cooled down, which represents an enormous stress for the product, e.g. for the fruit pieces, however.

Also, it is possible to subject the two product flows to a thermal treatment first and let them cool down before conveying them to the fillers. This requires that the section from the sterilizer or pasteurizer to the filler is sterile, however, in order for the product not to be recontaminated. However, this solution is technically complicated.

### SUMMARY OF THE DISCLOSURE

Based on the foregoing it is an aspect of the present disclosure to provide a method and an apparatus for the sterile filling of two different product flows into a container, which allow an instrumentally easier filling process, whilst treating the product with care.

According to the present disclosure a first product flow is thermally treated for pasteurizing/sterilizing it, is cooled down and fed to a filling valve, while the second product flow is thermally treated, and then, in the hot state, is added to the first product flow upstream of or in the filling valve. “Upstream of the filling valve” means without interposing a cooling device or a buffer tank.

This brings about the advantage that the second hot product flow can be cooled by the first product flow, so that no separate cooling section is necessary for the second product flow. Moreover, the distance covered by the second product flow until it is filled in need not be sterile because the second product flow is conveyed to the filling valve in a hot state. This results in a compact and cost-efficient system.

Also, it has the advantage that the second product flow containing, for example, fruit pieces can be rapidly cooled down by the first product flow, so that the product is treated with particular care.

It is particularly advantageous if the second product flow is added, in the hot s ate, to the first product flow in the filing valve because this maintains the sterility over the total distance covered by the second hot product flow to the filling valve without any additional measures, owing to the high temperature of the second product flow. The mixing temperature is then adjusted during the filling process. Such a system is instrumentally particularly simple.

Advantageously, the temperature of the first product flow during the mixing is in a range of 3 to 30° C., while the temperature of the second product flow is in a temperature range of 72 to 98° C. This means that the second product flow can be cooled down rapidly.

It is particularly advantageous if the volume flow of the first product flow is greater than that of the second product flow. This allows a very rapid cooling of the second product flow. According to a preferred embodiment the second product flow, after its thermal treatment, especially after a short-time heating or holding period, is added to the first product flow directly upstream of or in the filling valve. Hence, the system is further facilitated.

It is advantageous if the second product flow is fed back at least partially and/or for a certain time through a by-pass line to a device for the thermal treatment of the second product flow. This means that a portion of the second product flow is not added to the first product flow and is not fed to the filling valve, respectively, and that an excess flow, i.e. a surplus of the second product not filled in by the filling valve, can be fed back within the cycle to a device for the thermal treatment of the second product flow. This by-passing allows omission of a sterile buffer tank.

Advantageously, the first product has a lower viscosity than the second one. Due to the fact that the first product has a lower viscosity than the second product and the first product is cooled while the second is not, a cooling device can be realized more easily and more cost-efficiently. Advantageously, the first product may be a substantially homogenous liquid, especially water, juice or milk, while the second product is an inhomogeneous liquid provided with solid pieces, especially juice with pulp, juice with fibers or cells, syrup or cream. This means that, for example, the following different pairs of product flows may be filled into a container: juice/juice with pulp, juice/juice with fibers or cells, water/syrup, milk/cream.

An apparatus for the sterile filling of two different product flows into a container comprises a device for the thermal treatment of a first product flow and a device for cooling the first product flow. The cooling device may be configured, for example, in the form of a heat exchanger, preferably in the form of a plate heat exchanger. The already cooled product can then be stored intermediately in the downstream sterile buffer tank.

The second product flow is added to the first product flow in a mixing chamber, i.e. a mixing area. As was mentioned before it is particularly advantageous if the filling valve itself includes this mixing chamber. It is also possible, however, that the mixing chamber is arranged upstream of the filling valve in the direction of the product flow, so that the filling valve is fed with the mixed product flow. Upstream of the filling valve means in an area or conduit section between a device for the thermal treatment of the second product flow and the filling valve, with no cooling device being provided in this section.

Advantageously, the device for the thermal treatment of the second product flow is a sterilization/pasteurization unit which may comprise a feed tank, a heat exchanger, preferably of a tube heat exchanger, and a hot temperature maintaining section, e.g. in the form of coiled pipes, wherein the hot temperature maintaining section is directly connected via a conduit to the mixing chamber. This means that no sterile buffer tank is provided between the thermal treatment device, i.e. particularly between the hot temperature maintaining section and the mixing chamber and the filling valve, respectively.

Advantageously, a by-pass line is provided between the device for the thermal treatment of the second product flow and the mixing chamber and the filling valve, respectively, through which the second product flow can be fed back at least partially and/or for a certain time to the device for the thermal treatment of the product flow, especially to the feed tank. Thus, an excess flow (1 to 100%, preferably 5% of the total second product flow prior to branching off the by-pass flow) can be effectively fed back and supplied anew to the second product flow for the heating thereof.

The conduit section between the device for cooling the first product flow and the filling valve is preferably realized as a sterile conduit section. By this it can be ensured that the cold product flow is not contaminated with germs.

The disclosure brings about the advantage that only this small conduit section has to be realized as a sterile conduit section, and that the product can nevertheless be filled in with a minimum of required thermal load.

The volume flow in the by-pass line can be adjusted by a corresponding device. Such a device can be, for example, a regulating valve in the by-pass line and/or in the conduit to the mixing chamber or filling valve, respectively, and/or may be integrated in the mixing chamber or valve, respectively.

The disclosure will be explained in more detail below by means of the following figures:

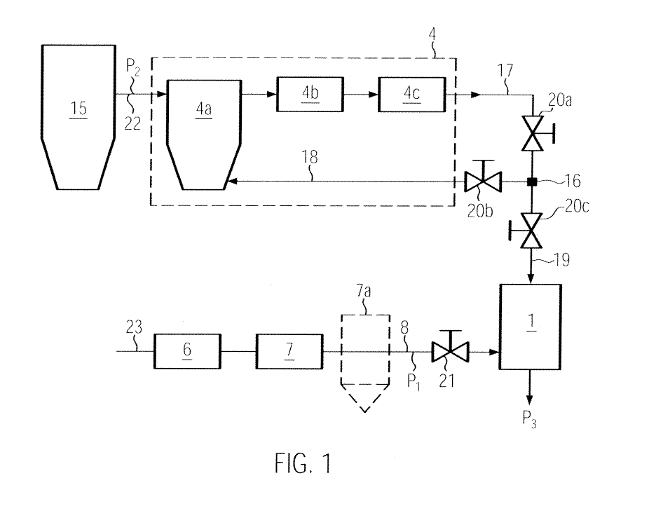

FIG. 1 schematically shows the structure of an apparatus according to an embodiment of the present disclosure;

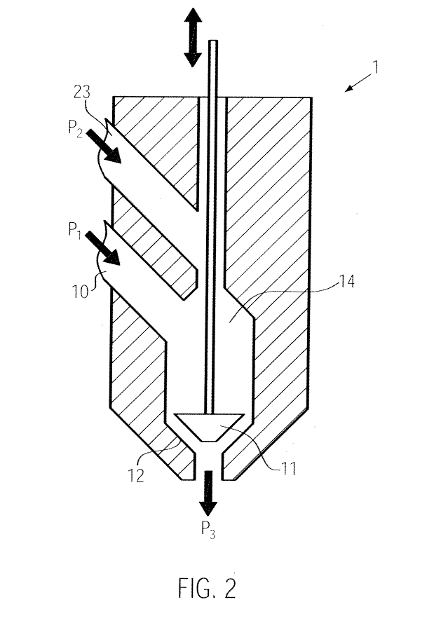

FIG. 2 schematically shows the structure of a filling valve according to the present disclosure;

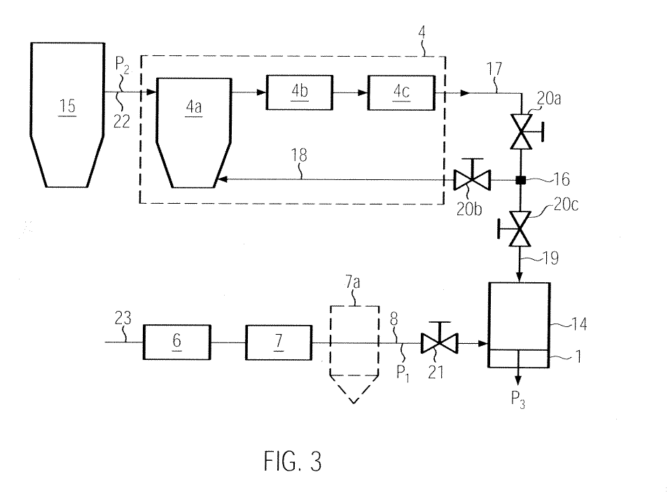

FIG. 3 shows another embodiment of the present disclosure.

### DETAILED DESCRIPTION OF THE PREFERRED EMBODIMENT

FIG. 1 schematically shows a first embodiment of the present disclosure. The apparatus comprises a feed line 22 through which a second product flow P2 can be fed to the apparatus. for example, from a mixing tank 15 by a non-illustrated pumping means. The apparatus further comprises a device 4 for the thermal aseptic treatment of the second product flow P2. Advantageously, this device 4 is a KZE heating unit (flash heating/flash pasteurization) which, as is shown in FIG. 1, particularly comprises a feed tank 4a, a heat exchanger 4b (plate or tube) as well as a hot temperature maintaining section 4c, e.g. in the form of coiled pipes. A conduit section 17, 19 is provided in the flow direction downstream of the device for the thermal aseptic treatment of the second product flow P2, through which the second product flow P2 can be fed to a filing valve 1. No further cooling device is provided in the conduit section 17 and 19, so that the product flow P2 can be fed to the valve 1 in a hot state. A turn-off 16 is located in the conduit section 17, 19, from which a by-pass line 18 leads away, through which the second product flow P2 can be fed back at least partially and/or for a certain time to the device 4 for the thermal treatment. This means that a freely adjustable excess flow can be fed back through the by-pass line 18 within the cycle. Due to this by-pass line 18 and the fact that the second product flow P2 is fed to the filling valve 1 in a hot state no sterile buffer tank and no further cooling device are here necessary. In this embodiment, the second product flow P2 is fed back through the by-pass line 18 to the buffer tank 4a. As an example, corresponding regulating valves 20a, 20b, 20c are provided for adjusting the respective volume flows, which are arranged, for example, in conduits 17, 19 and 20.

The apparatus further comprises a device 6 for the thermal aseptic treatment of a first product flow P1. This device 6 can, for example, also be a pasteurization unit, which is constructed, for example, as was explained in connection with unit 4. The hot product flow PI is then cooled by a cooling device. This device may be comprised of a heat exchanger 7 and/or a sterile buffer tank 7a. The section between the device 7, 7a for cooling the first product flow P1 is configured as a sterile conduit section 8. In order to provide a sterile conduit section, for example, the following measures are taken. Advantageously, the conduit section as well as all components are to be configured according to the hygienic design directives. This means that the construction has to include minimal clearance volumes, optimized surfaces, and has to be equipped, for example, with aseptically configured valves and regulating valves. Moreover, it is advantageous that the conduit section can be sterilized.

For example, a regulating valve 21 for adjusting the volume flow may be located in the conduit section 8. The product flow is generated by a non-illustrated pumping means. The first product flow P1 is fed to the filling valve 1 in a cold state. The regulating valves 20c and 21 are here provided in the conduits, but may also be integrated in the valve 1. It is essential that the ratio of the volume flows being mixed with each other is adjustable.

In the filling valve 1 the second product flow P2 is added to the first product flow P1 in a hot state. To this end, for example, the filling valve roughly schematically shown in FIG. 2 may be used. The filling valve 1 comprises a mixing chamber 14 which includes, for example, an upper inlet 23 for the second product flow P2 and another inlet 10 for the first product flow P1. The two flows are brought together in this zone. Bringing the hot product flow P2 together with the cold product flow P1 results in product flow P3 during the filling, which has a mixing temperature and can then flow into the container. Only roughly schematically shown are an upwardly and downwardly movable valve body 11 and a valve seat 12. It will be appreciated that the valve is not limited to this embodiment and may be constructed particularly in correspondence with the German patent applications having the application numbers 102009032791.6, 102009032794.0, 102009032795.9, 102009050388.9, which are incorporated herein in their entirety.

The first product is a substantially homogenous liquid, which is particularly transparent. The first product can be, for example, water, juice or also milk. The second product is, for example, an inhomogeneous liquid provided with solid matter, particularly such as juice with pulp, juice with fibers, juice with cells or, for example, syrup. The viscosity of the first product is lower than the viscosity of the second product. Accordingly, the first product is easier to cool than the second product, so that it is favorable if the first product flow P1 is cooled and the second product flow P2 is not cooled. The first product may, however, also be milk, and the second product may be cream.

FIG. 3 shows another embodiment of the present disclosure which corresponds to the embodiment shown in FIG. 1, with the exception that the second product flow P2 being in a hot state is added to the first product flow P1 upstream of the filling valve 1. This means that, in this embodiment, the filling valve 1 does not comprise the mixing chamber 14, but a mixing chamber 14 is provided in the flow direction upstream of the filling valve 1. This task is accomplished, for example, by an inline blender. In this case, too, the mixing chamber comprises an inlet for the first product flow P1 and an inlet for the second product flow P2, as well as an outlet through which the mixed product flow P3 can be fed to the filling valve 1, which then feeds product flow P3 to the container 3. The mixing chamber 14 may be directly adjacent to the valve 1, i.e. the outlet of the mixing chamber is adjacent to the inlet of the valve. However, a conduit section may also be provided between the mixing chamber 14 and the valve 1.

It is advantageous, however, to bring the product flows together directly in valve 1 because a corresponding configuration is easier. Moreover, it is ensured that conduit sections 17 and 19 between the device 4 for the thermal aseptic treatment and the filling valve 1 can be maintained at a temperature as high as possible. Also, the filling valve 1 is kept sterile by the hot product flow P2.

Below, the method according to the disclosure will be explained in more detail in connection with FIG. 1.

The second product flow P2 is fed, for example, from a mixing tank 15 through conduit 22 to the device 4 for the thermal aseptic treatment. The second product P2 is sterilized in this device 4 and flows out of this device 4 at a temperature in a range of 72 to 98° C., in the present case, for example, at 90° C. The volume flow is, for example, in a range of 10 to 20% of the overall flow P3, in this embodiment 2 m³/h. The second product flow then flows through the conduit 17 and 19 to the filling valve 1, with valves 20a, 20c being opened. Upon flowing into the filling valve 1 the product flow still has the aforementioned high temperature. An excess flow, i.e. a portion of the second product flow P2, can be fed back through the by-pass line 18 to the device 4 for the thermal aseptic treatment, i.e. in this case in the buffer tank 4a, to be reheated. The excess flow fed back in the by-pass line 18 amounts to approximately 1 to 5% of the volume flow of the second product flow P2 in conduit 17.

A first product flow is fed through conduit 23 to the device 6 for the thermal aseptic treatment. In this case, too, the product flow is heated and sterilized, and flows out of device 6, for example, at a temperature of 72 to 140° C. This hot first product flow P1 is then cooled down to a temperature of 3 to 30° C. at which it is fed through conduit section 8 to the filling valve 1. The first product flow P1 can be cooled down by a heat exchanger 7 and/or stored in a sterile buffer tank 7a in which the product cools down or is cooled down further. If the regulating valve 21 is opened the first product flow can then be fed to the valve 1 at a volume flow of 6 to 60 m³/h. The first product flow P1 has then, for example, a temperature of 15° C. and a volume flow of 23 m³/h.

As a result of adding the second product flow P2 to the first product flow P1 in a hot state the second product flow can be cooled down by the first product flow P1. The result is a mixed flow P3 having a mixing temperature. As the volume flow of the first product flow P1 is greater than that of the second product flow P2 the hot product flow P2 can be cooled down particularly rapidly. Due to the fact that the hot second product flow P2 is able to cool down relatively rapidly, for example, portions of fruit pieces or thermally sensitive ingredients can be filled in with particular care.

The method was explained on the basis of the first embodiment. The method according to the disclosure works in the same way with the second embodiment shown in FIG. 3. However, in this embodiment, the product flows are brought together in a mixing chamber 14 located in the flow direction upstream of the filling valve 1.

1. Method for the sterile filling of two different product flows into a container, comprising:
thermally treating the first product flow for pasteurizing/sterilizing, and cooling down and feeding the first product flow to a filling valve, and
thermally treating the second product flow for pasteurizing/sterilizing, and then, in the hot state, adding the second product flow to the first product flow upstream of or in the filling valve.

2. Method according to claim 1, wherein, during the mixing, the temperature of the first product flow is in a range of 3 to 30° C., while the temperature of the second product flow is in a temperature range of 72 to 98° C.

3. Method according to claim 1, wherein, during the mixing, the volume flow of the first product flow (P1) is greater than that of the second product flow (P2).

4. Method according to claim 1, and adding the second product flow, after a short-time heating and holding period, to the first product flow directly upstream of or in the filling valve.

5. Method according to claim 1, and feeding back the second product flow at least partially and/or for a certain time through a by-pass line to a device for the thermal treatment of the first product flow.

6. Method according to claim 1, wherein the first product has a lower viscosity than the second product and the first product is preferably a substantially homogenous liquid, while the second product is an inhomogeneous liquid.

7. Apparatus for the sterile filling of two different product flows into a container, comprising:
a device for the thermal aseptic treatment of a first product flow,
a device for cooling down the first product flow,
a device for the thermal aseptic treatment of a second product flow,
a filling valve comprising a mixing chamber or being connected to a mixing chamber, wherein the mixing chamber is arranged in such a way that the hot second product flow can be added to the cooled first product flow and the intermixed product flow can be fed to the container.

8. Apparatus according to claim 7, wherein the device for the thermal treatment of the second product flow is a sterilization/pasteurization unit comprising a feed tank, a heat exchanger and a hot temperature maintaining section, wherein the hot temperature maintaining section is directly connected via a conduit to the mixing chamber.

9. Apparatus according to claim 7, wherein, starting from a conduit, a by-pass line is provided between the device for the thermal treatment of the second product flow and the mixing chamber and the filling valve, respectively, through which the second product flow can be fed back at least partially and/or for a certain time to the device for the thermal treatment of the second product flow.

10. Apparatus according to claim 8, wherein the by-pass line leads into the feed tank.

11. Apparatus according to claim 7, wherein a conduit section between the device for cooling the first product flow and the filling valve is realized as a sterile conduit section.

12. Apparatus according to claim 9, wherein the apparatus comprises a device for adjusting the volume flow in the by-pass line.

13. Method according to claim 6, wherein the first product is one of water, juice or milk.

14. Method according to claim 6, wherein the second product is one provided with one of solid pieces, fibers, cells, syrup or cream.

15. Method according to claim 14, wherein the second liquid provided with solid pieces is juice with pulp.
